(19) United States
(12) Patent Application Publication
(10) Pub. No.: US 2017/0169012 A1
(43) Pub. Date: Jun. 15, 2017

(54) Method and System for Synonym Data Mining

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventor: Jiannan LI, Beijing (CN)

(73) Assignees: LE HOLDINGS (BEIJING) CO., LTD., Beijing (CN); LE SHI INTERNET INFORMATION & TECHNOLOGY CORP., BEIJING, Beijing (CN)

(21) Appl. No.: 15/242,271

(22) Filed: Aug. 19, 2016

Related U.S. Application Data
(63) Continuation of application No. PCT/CN2016/088681, filed on Jul. 5, 2016.

(30) Foreign Application Priority Data
Dec. 9, 2015 (CN) 201510908015.2

(51) Int. Cl. G06F 17/27; G06N 5/04; G06N 99/00; G06F 17/30

(52) U.S. Cl. CPC G06F 17/2795; G06F 17/30675; G06N 5/045; G06N 99/005

(57) ABSTRACT

The present disclosure discloses a method and an electronic device for synonym data mining. The method includes: acquiring a vocabulary pair and a similarity value of the vocabulary pair in a dictionary, a video file library and a search log record, and establishing a candidate synonym library in which the vocabulary pair is associated with the similarity value of the vocabulary pair; training and obtaining a synonym model according to data information in the candidate synonym library; obtaining an output value by substituting the similarity value corresponding to each vocabulary pair in the candidate synonym library into the synonym model; and storing a vocabulary pair with an output value greater than a preset threshold in a synonym library.

### CROSS-REFERENCE TO RELATED APPLICATION

This application is a continuation of International Application No. PCT/CN2016/088681, with an international filing date of Jul. 5, 2016, which claims the priority to CN Application No. 201510908015.2 filed with the State Intellectual Property Office on Dec. 9, 2015, titled “METHOD AND SYSTEM FOR SYNONYM DATA MINING”, both of which are incorporated herein by reference in its entireties.

### TECHNICAL FIELD

The present disclosure relates to the field of media transmission technologies, and in particular, to a method and an electronic device for synonym data mining.

### BACKGROUND

With the rapid development of network technologies, people's demands on network are embodied in every corner of life, and have a profound influence on society. Data mining generally refers to a process of automatically searching hidden information with a special relation from a large amount of data. Data mining is usually related to computer science, and it may be realized by various methods such as statistics, on-line analysis, information retrieve, machine learning, expert system and pattern recognition, etc.

At present, in a network retrieval application in which data mining is combined with network technologies, a keyword may be input, and all related contents may be retrieved according to the keyword. However, a network retrieval application can retrieve the contents with the same keyword, thus the retrieval range is small, which cannot meet retrieval demand of a user. Additionally, if the keyword input is inaccurate, the target content may not be retrieved. During the use of a network retrieval application, a large quantity of time needs to be spent on the determination of a keyword.

### SUMMARY

In a first aspect, a method for synonym data mining according to one embodiment of the disclosure includes:

acquiring a vocabulary pair and a similarity value of the vocabulary pair in a dictionary, a video file library and a search log record, and establishing a candidate synonym library in which the vocabulary pair is associated with the similarity value of the vocabulary pair;

training and obtaining a synonym model according to data information in the candidate synonym library;

obtaining an output value by substituting the similarity value corresponding to each vocabulary pair in the candidate synonym library into the synonym model; and storing a vocabulary pair with an output value greater than a preset threshold in a synonym library.

In a second aspect, one embodiment of the disclosure provides a non-volatile computer-readable storage medium stored with computer executable instructions, the computer executable instructions are configured to perform any of the methods for synonym data mining of the present disclosure as described above.

In a third aspect, one embodiment of the disclosure further provides an electronic device including at least one processor; wherein, the memory is communicably connected with the at least one processor for storing instructions executed by the at least one processor, the computer executable instructions are configured to perform any of the methods for synonym data mining of the present disclosure as described above.

### BRIEF DESCRIPTION OF THE DRAWINGS

One or more embodiments are illustrated by way of examples, and not by limitation, in the figures of the accompanying drawings, wherein elements having the same reference numeral designations represent like elements throughout. The drawings are not to scale, unless otherwise disclosed.

FIG. 1 is a schematic flow chart of a method for synonym data mining according to the first embodiment of the disclosure;

FIG. 2 is a schematic flow chart of a method for synonym data mining according to a referable embodiment of the disclosure; and

FIG. 3 is a structural representation of a system for synonym data mining according to the disclosure.

FIG. 4 is a block diagram of an electronic device provided by an embodiment of the present disclosure.

### DETAILED DESCRIPTION

In order to make the objects, technical solution and advantages of the disclosure more apparent, the disclosure will be further illustrated in detail in conjunction with specific embodiments and referring to the drawings.

According to the present use status of network retrieval applications, a user cannot retrieve more contents in accordance with the retrieval demand of the user. As a result, each user may find a very little information on the network retrieval application, which can only be contents with the same keyword. In order to solve such a problem, the disclosure perceives, in the visual angle of a user, that the user hopes to retrieve more contents on a network retrieval application. Therefore, the concept of the disclosure is to set a synonym retrieving function on a network retrieval application.

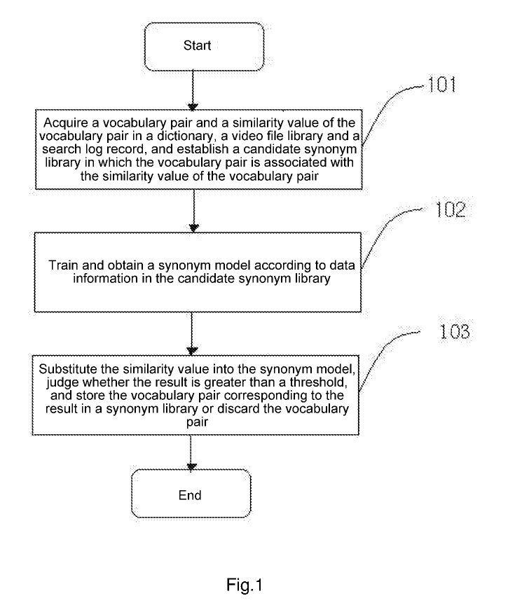

Referring to FIG. 1, it shows a schematic flow chart of a method for synonym data mining according to the first embodiment of the disclosure, wherein, the method for synonym data mining includes:

In step 101, a vocabulary pair and a similarity value of the vocabulary pair are acquired in a dictionary, a video file library and a search log record, and a candidate synonym library in which the vocabulary pair is associated with the similarity value of the vocabulary pair is established.

Optionally, a preliminary synonym library is established based on a dictionary, and associated vocabulary pairs and similarity values of the vocabulary pairs are stored in the dictionary preliminary synonym library. Specifically, all vocabularies in the dictionary are encoded, and vocabularies appearing in a vocabulary explanation are taken as preliminary synonym vectors. Then, they are arranged according to a tree structure, in which the vocabulary is taken as a parent node, and the preliminary synonym vectors thereof are taken as child nodes. A similarity value between each vocabulary and each preliminary synonym vector corresponding to the vocabulary is then calculated by using a vector cosine similarity algorithm.

Optionally, a preliminary synonym library is established based on a video file, and associated vocabulary pairs and similarity values of the vocabulary pairs are stored in the video file preliminary synonym library. Specifically, a title of a video is extracted from a preset video file library, and vocabularies appearing in the same title are added into the preliminary synonym vectors of each other; for a vocabulary w1 and a synonym w2 corresponding to w1, the similarity

$$rel ( w 1 , w 2 ) = \sqrt{\frac{count ( w 1 , w 2 ) * count ( w 1 , w 2 )}{count ( w 1 ) * count ( w 2 )}}$$

between the vocabulary and each preliminary synonym vector corresponding to the vocabulary is calculated; wherein, count (w1) is the number of titles in which w1 appears, count (w2) is the number of titles in which w2 appears, and count (w1, w2) is the number of titles in which w1 and w2 appear simultaneously.

In another optional embodiment, a preliminary synonym library is established based on a search log record, and associated vocabulary pairs and similarity values of the vocabulary pairs are stored in the search log record preliminary synonym library. Specifically, taking vocabularies appearing in the same query request and vocabularies in query requests that are different but provide the same search result as preliminary synonym vectors of each other; for a vocabulary w1 and a synonym w2 corresponding to w1, the similarity

$$rel ( w 1 , w 2 ) = \sqrt{\frac{count ( w 1 , w 2 ) * same ( w 1 , w 2 )}{count ( w 1 ) * count ( w 2 )}}$$

between the vocabulary and each preliminary synonym vector corresponding to the vocabulary is calculated; wherein, count (w1) is the number of queries in which w1 appears, count (w2) is the number of queries in which w2 appears, count (w1, w2) is the number of queries in which w1 and w2 appear simultaneously, and same (w1, w2) is the number of different queries with the same search result in which w1 and w2 appear respectively.

Optionally, all vocabulary pairs commonly having a preliminary synonym relation in the dictionary preliminary synonym library, the video file preliminary synonym library and the search log record preliminary synonym library are acquired. Moreover, the corresponding similarity values of each vocabulary pair in the dictionary preliminary synonym library, the video file preliminary synonym library and the search log record preliminary synonym library respectively are extracted. Then, a candidate synonym library is established.

As another embodiment, the similarity values of each vocabulary pair in the dictionary, the video file library and the search log record are summarized and averaged, and the average value is stored in the candidate synonym library. Therefore, the candidate synonym library is expressed as (w1, w2, T1, T2, T3, T), wherein T1 is the similarity value of vocabulary pair w1, w2 in the dictionary, T2 is the similarity value of vocabulary pair w1, w2 in the video file library, T3 is the similarity value of vocabulary pair w1, w2 in the search log record, and T is an average similarity value of vocabulary pair w1, w2.

In step 102, a synonym model is trained and obtained according to data information in the candidate synonym library.

Optionally, the 1^{st} to the n^{th} data information (w1, w2, T) is extracted from the candidate synonym library as an input, the (n+1)^{th} to the 2n^{th} data information (w1, w2, T) is extracted from the candidate synonym library as an output, and a gradient boosting decision tree model is trained. Then, a synonym gradient boosting decision tree model is obtained: F(T)=α₁β₁(T)+α₂β₂(T)+ . . . +αₘβₘ(T),

wherein, β₁-βₘ represents m decision trees, α₁-αₘ represents the weight of each decision tree, and T represents an average value obtained by summarizing and averaging the similarity values of three vectors corresponding to each vocabulary pair.

In step 103, the similarity value corresponding to each vocabulary pair in the candidate synonym library is substituted into the synonym model, and whether the output value obtained is greater than a preset threshold is judged; if yes, the vocabulary pair corresponding to the output value is extracted from the candidate synonym library and is stored in the synonym library; if not, the vocabulary pair corresponding to the result is discarded.

Optionally, the average similarity value corresponding to each vocabulary pair in the candidate synonym library is substituted into the synonym gradient boosting decision tree model, and an output result of the synonym gradient boosting decision tree model is obtained.

It should be noted that, the synonym library formed finally can be used in a retrieval application, In use, by acquiring the keyword input by a user, synonyms corresponding to the keyword may be found in the synonym library, and then the information related to the keyword and the synonyms thereof may be searched. It should be noted that, when the synonym library is applied to various search applications, a user may select whether to search the synonyms of a keyword at the moment that the keyword is input for search; if yes, the information related to the keyword and the synonyms thereof may be searched; if not, only the information related to the keyword may be searched. Therefore, it can be seen that in the disclosure, not only an highly-accurate synonym library can be established, but it can also be provided to a retrieval application, and more importantly, a user can be provided with a function of autonomously setting whether to perform synonym retrieve.

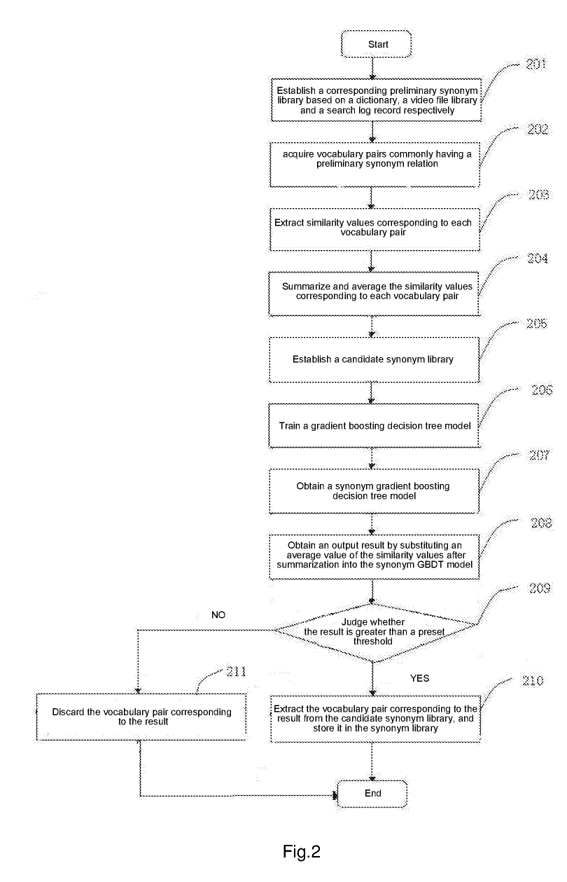

As a referable embodiment, as shown in FIG. 2, a method for synonym data mining may specifically includes the steps below:

In step 201, a corresponding preliminary synonym library is established based on a dictionary, a video file library and a search log record respectively;

As an embodiment, when a preliminary synonym library is established based on a dictionary, all vocabularies are encoded, and the vocabularies appearing in the explanation of each vocabulary may be taken as preliminary synonym vectors, and then they are arranged according to a tree structure. That is, the vocabulary is taken as a parent node, and the preliminary synonym vectors thereof are taken as child nodes. Finally, a similarity value between each vocabulary and each preliminary synonym vector corresponding to the vocabulary is calculated by using a vector cosine similarity algorithm.

When a preliminary synonym library is established based on a video file, a title of a video is extracted from a preset video file library, and vocabularies appearing in the same title are added into the preliminary synonym vectors of each other. Optionally, when the similarity between each vocabulary and each preliminary synonym vector corresponding to the vocabulary is calculated, the following method is employed: for a vocabulary w1 and a synonym w2 corresponding to w1, the number of titles in which w1 appears is counted and recorded as count (w1), similarly, the number of titles in which w2 appears is counted and recorded as count (w2), and then the number of titles in which w1 and w2 appear simultaneously is recorded as count (w1, w2), and the similarity between w1 and w2 is calculated:

$$rel ( w 1 , w 2 ) = \sqrt{\frac{count ( w 1 , w 2 ) * count ( w 1 , w 2 )}{count ( w 1 ) * count ( w 2 )}} .$$

When a preliminary synonym library is established based on a search log record, for two vocabularies w1 and w2, based on a user search log record, the number of queries in which w1 appears is counted and recorded as count (w1), and similarly, the number of queries in which w2 appears is counted and recorded as count (w2). The number of queries in which w1, w2 appear simultaneously is recorded as count (w1, w2), that is, w1 and w2 are preliminary synonym vectors of each other. Additionally, the number of different queries with the same search result in which w1 and w2 appear respectively is recorded as same (w1, w2). The similarity between w1 and w2 is calculated:

$$rel ( w 1 , w 2 ) = \sqrt{\frac{count ( w 1 , w 2 ) * same ( w 1 , w 2 )}{count ( w 1 ) * count ( w 2 )}} .$$

In step 202, all vocabulary pairs commonly having a preliminary synonym relation in the dictionary preliminary synonym library, the video file preliminary synonym library and the search log record preliminary synonym library are acquired;

In step 203, similarity values corresponding to each vocabulary pair in the dictionary preliminary synonym library, the video file preliminary synonym library and the search log record preliminary synonym library are extracted respectively;

In step 204, the similarity values of three vectors corresponding to each vocabulary pair in the candidate synonym library are summarized and averaged to obtain an average T;

In step 205, a candidate synonym library is established;

In one embodiment, vocabulary pairs are stored in the candidate synonym library, and the corresponding similarity values of the vocabulary pair in the dictionary preliminary synonym library, the video file preliminary synonym library and the search log record preliminary synonym library, i.e., the similarities of three vectors, are stored for each vocabulary pair. In one specific implementation mode, the candidate synonym library is denoted (w1, w2, T1, T2, T3), wherein w1 and w2 are vocabularies with a preliminary synonym relation, T1 is the similarity of vectors in the dictionary preliminary synonym library, T2 is the similarity of vectors in the video file preliminary synonym library, and T3 is the similarity of vectors in the search log record preliminary synonym library.

In step 206, the 1^{st} to the n^{th} data information (w1, w2, T) is extracted from the candidate synonym library as an input, the (n+1)^{th} to the 2n^{th} data information (w1, w2, T) is extracted from the candidate synonym library as an output, and a gradient boosting decision tree (GBDT) model is trained.

In step 207, a synonym gradient boosting decision tree (GBDT) model is obtained:

F(T)=α₁β₁(T)+α₂β₂(T)+ . . . +αₘβₘ(T)

wherein, β₁-βₘ represents m decision trees, α₁-αₘ represents the weight of each decision tree, and T represents an average value obtained by summarizing and averaging the similarity values of three vectors corresponding to each vocabulary pair.

In step 208, an output value is obtained by substituting an average value of the similarity values of three vectors corresponding to each vocabulary pair in the candidate synonym library into the synonym GBDT model;

In step 209, whether the output value is greater than a preset threshold is judged, if yes, turning to Step 210; if not, turning to Step 211;

In step 210, the vocabulary pair corresponding to the output value is extracted from the candidate synonym library, and is stored in the synonym library;

In step 211, the vocabulary pair corresponding to the result is discarded.

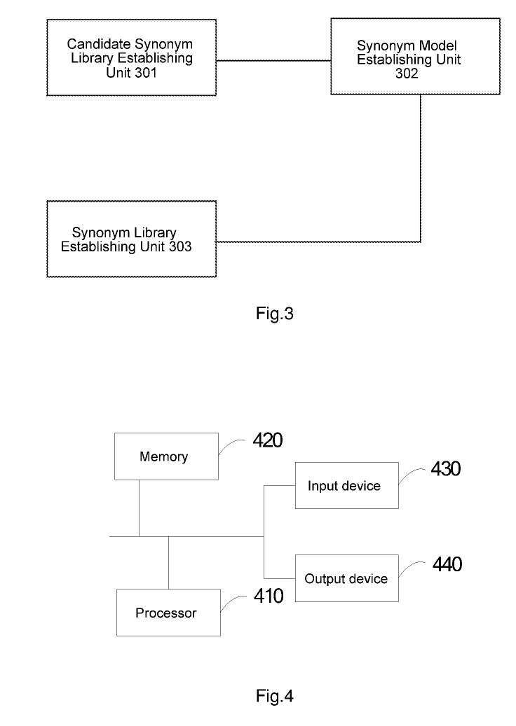

In another aspect of the disclosure, it is further provided a system for synonym data mining. As shown in FIG. 3, the system for synonym data mining includes a candidate synonym library establishing unit 301, a synonym model establishing unit 302 and a synonym library establishing unit 303 that are sequentially connected; wherein, the candidate synonym library establishing unit 301 acquires a vocabulary pair and a similarity value of the vocabulary pair in a dictionary, a video file library and a search log record, and establishes a candidate synonym library in which the vocabulary pair is associated with the similarity value of the vocabulary pair; the synonym model establishing unit 302 trains and obtains a synonym model according to data information in the candidate synonym library; and the synonym library establishing unit 303 obtains an output value by substituting the similarity value corresponding to each vocabulary pair in the candidate synonym library into the synonym model, and storing a vocabulary pair with an output value greater than a preset threshold in a synonym library.

Optionally, by the candidate synonym library establishing unit 301, a preliminary synonym library is established based on a dictionary, and associated vocabulary pairs and similarity values of the vocabulary pairs are stored in the dictionary preliminary synonym library. Specifically, all vocabularies in the dictionary are encoded, and vocabularies appearing in a vocabulary explanation are taken as preliminary synonym vectors. Then, they are arranged according to a tree structure, in which the vocabulary is taken as a parent node, and the preliminary synonym vectors thereof are taken as child nodes. A similarity value between each vocabulary and each preliminary synonym vector corresponding to the vocabulary is then calculated by using a vector cosine similarity algorithm.

A preliminary synonym library is established based on a video file, and associated vocabulary pairs and similarity values of the vocabulary pairs are stored in the video file preliminary synonym library. Specifically, a title of a video is extracted from a preset video file library, and vocabularies appearing in the same title are added into the preliminary synonym vectors of each other; for a vocabulary w1 and a synonym w2 corresponding to w1, the similarity

$$rel ( w 1 , w 2 ) = \sqrt{\frac{count ( w 1 , w 2 ) * count ( w 1 , w 2 )}{count ( w 1 ) * count ( w 2 )}}$$

between the vocabulary and each preliminary synonym vector corresponding to the vocabulary is calculated; wherein, count (w1) is the number of titles in which w1 appears, count (w2) is the number of titles in which w2 appears, and count (w1, w2) is the number of titles in which w1 and w2 appear simultaneously.

A preliminary synonym library is established based on a search log record, and associated vocabulary pairs and similarity values of the vocabulary pairs are stored in the search log record preliminary synonym library. Specifically, vocabularies appearing in the same query request and vocabularies in query requests that are different but provide the same search result are taken as preliminary synonym vectors of each other; for a vocabulary w1 and a synonym w2 corresponding to w1, the similarity

$$rel ( w 1 , w 2 ) = \sqrt{\frac{count ( w 1 , w 2 ) * same ( w 1 , w 2 )}{count ( w 1 ) * count ( w 2 )}}$$

between the vocabulary and each preliminary synonym vector corresponding to the vocabulary is calculated; wherein, count (w1) is the number of queries in which w1 appears, count (w2) is the number of queries in which w2 appears, count (w1, w2) is the number of queries in which w1 and w2 appear simultaneously, and same (w1, w2) is the number of different queries with the same search result in which w1 and w2 appear respectively.

Optionally, by the candidate synonym library establishing unit 301, all vocabulary pairs commonly having a preliminary synonym relation in the dictionary preliminary synonym library, the video file preliminary synonym library and the search log record preliminary synonym library are acquired. Moreover, the corresponding similarity values of each vocabulary pair in the dictionary preliminary synonym library, the video file preliminary synonym library and the search log record preliminary synonym library respectively are extracted. Then, a candidate synonym library is established.

Additionally, by the candidate synonym library establishing unit 301, the similarity values of each vocabulary pair in the dictionary, the video file library and the search log record are summarized and averaged, and the average value is stored in the candidate synonym library. Therefore, the candidate synonym library is denoted (w1, w2, T1, T2, T3, T), wherein T1 is the similarity value of vocabulary pair w1, w2 in the dictionary, T2 is the similarity value of vocabulary pair w1, w2 in the video file library, T3 is the similarity value of vocabulary pair w1, w2 in the search log record, and T is an average similarity value of vocabulary pair w1, w2.

As another embodiment, the synonym model establishing unit 302 extracts the 1^{st} to the n^{th} data information (w1, w2, T) from the candidate synonym library as an input, extracts the (n+1)^{th} to the 2n^{th} data information (w1, w2, T) from the candidate synonym library as an output, and trains a gradient boosting decision tree model. Then, a synonym gradient boosting decision tree model is obtained:

F(T)=α₁β₁(T)+α₂β₂(T)+ . . . +αₘβₘ(T)

wherein, β₁-βₘ represents m decision trees, α₁-αₘ represents the weight of each decision tree, and T represents an average value obtained by summarizing and averaging the similarity values of three vectors corresponding to each vocabulary pair.

Optionally, the synonym library establishing unit 303 substitutes the average similarity value corresponding to each vocabulary pair in the candidate synonym library into the synonym gradient boosting decision tree model, and obtains an output result of the synonym gradient boosting decision tree model.

It should be noted that, the specific implementation of the system for synonym data mining according to the disclosure have been illustrated in detail in the description with respect to the method for synonym data mining as described above, so it will not be illustrated again here.

In conclusion, by the method and the system for synonym data mining according to the embodiments of the disclosure, a method and a system for establishing a synonym library are provided creatively. Moreover, the synonyms in the synonym library are all highly-accurate synonym pairs obtained via multi-layer filtration and calculation. Further, the synonym library can be applied to a search application, which not only meets the requirement of a user for retrieving more contents, but also meets the requirement of a user for customizing the contents to be retrieved (whether to include the retrieval result of synonyms). Therefore, the disclosure has a wide and important sense of popularization. Finally, the method and the system for synonym data mining are compact and easy to be limited.

One embodiment of the disclosure further provides a non-volatile computer-readable storage medium, stored with computer executable instructions that, when executed by an electronic device, cause the electronic device to execute any of the embodiments of the methods for synonym data mining of the present disclosure as described above.

FIG. 4 is a structural representation of hardware of an electronic device used to perform the method for synonym data mining according to an embodiment of the present disclosure. As shown in FIG. 4, the device includes:

at least one processor 410 and a memory 420. FIG. 4 illustrates one proscessor 410 as an example.

The electronic device for the method for synonym data mining may further include an input device 430 and an output device 440.

The processor 410, the memory 420, the input device 430 and the output device 440 may be connected with each other through bus or other types of connections. FIG. 4 illustrates bus connection as an example.

As a non-volatile computer readable storage medium, the memory 420 may be configured to store non-volatile software program, non-volatile computer executable program and modules, such as program instructions/modules corresponding to the method for synonym data mining according to the embodiments of the disclosure (for example, the candidate synonym library establishing unit 301, the synonym model establishing unit 302, and the synonym library establishing unit 303 as illustrated in FIG. 3. By executing the non-volatile software program, instructions and modules stored in the memory 420, the processor 410 may perform various functional applications of the server and data processing, that is, the method for synonym data mining according to the above mentioned embodiments.

The memory 420 may include a program storage area and a data storage area, wherein, the program storage area may store the operating system and necessary applications for at least one functions, and the data storage area may store data which is created according to use of the device for mining synonym library. Further, the memory 420 may include a high-speed random access memory, and may further include non-volatile memory, such as at least one of disk memory device, flash memory device or other types of non-volatile solid state memory device. In some embodiments, optionally, the memory 420 may include memory provided remotely relative to the processor 410, and such remote memory may be connected with the device for synonym data mining through network connections. The examples of the network connections may include but not limited to internet, intranet, LAN (Local Area Network), mobile communication network and combinations thereof.

The input device 430 may receive inputted number or character information, and generate key signal input related to the user settings and functional control of the device for synonym data mining. The output device 440 may include a display device such as a display screen.

The above one or more modules may be stored in the memory 420. When these modules are executed by the one or more processors 410, the method for synonym data mining according to any of the above mentioned method embodiments may be performed.

The above product may perform the methods provided in the embodiments of the disclosure, and include functional modules and advantageous effects corresponding to these methods. For the further technical details which are not described in detail in the present embodiment, refer to the description in relation to the method according to embodiments of the disclosure.

The electronic device in the embodiment of the present disclosure exists in various forms, including but not limited to:

(1) mobile communication device, characterized in having a function of mobile communication mainly aimed at providing speech and data communication, wherein such terminal includes: smart phone (such as iPhone), multimedia phone, functional phone, low end phone and the like;

(2) ultra mobile personal computer device, which falls in a scope of personal computer, has functions of calculation and processing, and generally has characteristics of mobile internet access, wherein such terminal includes: PDA, MID and UMPC devices, such as iPad;

(3) portable entertainment device, which can display and play multimedia contents, and includes audio or video player (such as iPod), portable game console, E-book and smart toys and portable vehicle navigation device;

(4) server, an device for providing computing service, constituted by processor, hard disc, internal memory, system bus, and the like, which has a framework similar to that of a computer, but is demanded for superior processing ability, stability, reliability, security, extendibility and manageability due to that high reliable services are desired; and

(5) other electronic devices having a function of data interaction.

The above mentioned examples for the device are merely exemplary, wherein the unit illustrated as a separated component may be or may not be physically separated, the component illustrated as a unit may be or may not be a physical unit, in other words, may be either disposed in some place or distributed to a plurality of network units. All or part of modules may be selected as actually required to realize the objects of the present disclosure.

According to the description in connection with the above embodiments, it can be clearly understood by ordinary skill in the art that various embodiments can be realized by means of software in combination with necessary universal hardware platform, and certainly, may further be realized by means of hardware. Based on such understanding, the above technical solutions in substance or the part thereof that makes a contribution to the prior art may be embodied in a form of a software product which can be stored in a computer-readable storage medium, such as ROM/RAM, magnetic disk and compact disc, and includes several instructions for allowing a computer device (which may be a personal computer, a server, a network device or the like) to execute the methods described in various embodiments or some parts thereof.

Finally, it should be stated that, the above embodiments are merely used for illustrating the technical solutions of the present disclosure, rather than limiting them. Although the present disclosure has been illustrated in details in reference to the above embodiments, it should be understood by ordinary skill in the art that some modifications can be made to the technical solutions of the above embodiments, or part of technical features can be substituted with equivalents thereof. Such modifications and substitutions do not cause the corresponding technical features to depart in substance from the spirit and scope of the technical solutions of various embodiments of the present disclosure.

What is claimed is:

1. A method for synonym data mining, comprising:
acquiring a vocabulary pair and a similarity value of the vocabulary pair in a dictionary, a video file library and a search log record, and establishing a candidate synonym library in which the vocabulary pair is associated with the similarity value of the vocabulary pair;
training and obtaining a synonym model according to data information in the candidate synonym library;
obtaining an output value by substituting the similarity value corresponding to each vocabulary pair in the candidate synonym library into the synonym model; and
storing a vocabulary pair with an output value greater than a preset threshold in a synonym library.

2. The method according to claim 1, wherein, the acquiring a vocabulary pair and a similarity value of the vocabulary pair in a dictionary comprises:
encoding all vocabularies in a dictionary, taking the vocabularies appearing in the vocabulary explanation of each vocabulary as preliminary synonym vectors, arranging the preliminary synonym vectors according to a tree structure, in which each vocabulary is taken as a parent node and the preliminary synonym vectors thereof are taken as child nodes, and then calculating a similarity value between each vocabulary and each preliminary synonym vector corresponding to the vocabulary by using a vector cosine similarity algorithm;
the acquiring a vocabulary pair and a similarity value of the vocabulary pair in a video file library comprises: extracting a title of a video from a preset video file library, and adding vocabularies appearing in the same title into the preliminary synonym vectors of each other; for a vocabulary w1 and a synonym w2 corresponding to w1, calculating the similarity
$$rel ( w 1 , w 2 ) = \sqrt{\frac{count ( w 1 , w 2 ) * count ( w 1 , w 2 )}{count ( w 1 ) * count ( w 2 )}}$$
between the vocabulary and each preliminary synonym vector corresponding to the vocabulary; wherein, count (w1) is the number of titles in which w1 appears, count (w2) is the number of titles in which w2 appears, and count (w1, w2) is the number of titles in which w1 and w2 appear simultaneously;
the acquiring a vocabulary pair and a similarity value of the vocabulary pair in a search log record comprises: taking vocabularies appearing in the same query request and vocabularies in query requests that are different but provide the same search result as preliminary synonym vectors of each other; for a vocabulary w1 and a synonym w2 corresponding to w1, calculating the similarity
$$rel ( w 1 , w 2 ) = \sqrt{\frac{count ( w 1 , w 2 ) * same ( w 1 , w 2 )}{count ( w 1 ) * count ( w 2 )}}$$
between the vocabulary and each preliminary synonym vector corresponding to the vocabulary; wherein, count (w1) is the number of queries in which w1 appears, count (w2) is the number of queries in which w2 appears, count (w1, w2) is the number of queries in which w1 and w2 appear simultaneously, and same (w1, w2) is the number of different queries with the same search result in which w1 and w2 appear.

3. The method according to claim 2, wherein, before establishing a candidate synonym library in which the vocabulary pair is associated with the similarity value of the vocabulary pair, the method further comprises:
summarizing and averaging the similarity values of each vocabulary pair in the dictionary, the video file library and the search log record, and storing the average value in the candidate synonym library;
wherein the candidate synonym library is denoted (w1, w2, T1, T2, T3, T), wherein T1 is the similarity value of vocabulary pair w1, w2 in the dictionary, T2 is the similarity value of vocabulary pair w1, w2 in the video file library, T3 is the similarity value of vocabulary pair w1, w2 in the search log record, and T is an average similarity value of vocabulary pair w1, w2.

4. The method according to claim 3, wherein, the training and obtaining a synonym model comprises: extracting the 1^{st} to the n^{th} data information (w1, w2, T) from the candidate synonym library as an input, extracting the (n+1)^{th} to the 2n^{th} data information (w1, w2, T) from the candidate synonym library as an output, and training a gradient boosting decision tree model;
obtaining a synonym gradient boosting decision tree model:
F(T)=α₁β₁(T)+α₂β₂(T)+ . . . +αₘβₘ(T);
wherein, β₁-βₘ represents m decision trees, α₁-αₘ represents the weight of each decision tree, and T represents an average value obtained by summarizing and averaging the similarity values of three vectors corresponding to each vocabulary pair.

5. The method according to claim 4, wherein, the substituting the similarity value corresponding to each vocabulary pair in the candidate synonym library into the synonym model comprises: substituting the similarity value corresponding to each vocabulary pair in the candidate synonym library into the synonym gradient boosting decision tree model, and acquiring an output value from the synonym gradient boosting decision tree model.

6. A non-volatile computer-readable storage medium, stored with computer executable instructions that, when executed by an electronic device, cause the electronic device to:
acquire a vocabulary pair and a similarity value of the vocabulary pair in a dictionary, a video file library and a search log record, and establish a candidate synonym library in which the vocabulary pair is associated with the similarity value of the vocabulary pair;
train and obtain a synonym model according to data information in the candidate synonym library;
obtain an output value by substituting the similarity value corresponding to each vocabulary pair in the candidate synonym library into the synonym model; and
store a vocabulary pair with an output value greater than a preset threshold in a synonym library.

7. The non-volatile computer-readable storage medium according to claim 6, wherein, the instructions to acquire a vocabulary pair and a similarity value of the vocabulary pair in a dictionary cause the electronic device to:
encode all vocabularies in a dictionary, take the vocabularies appearing in the vocabulary explanation of each vocabulary as preliminary synonym vectors, arrange the preliminary synonym vectors according to a tree structure, in which each vocabulary is taken as a parent node and the preliminary synonym vectors thereof are taken as child nodes, and then calculate a similarity value between each vocabulary and each preliminary synonym vector corresponding to the vocabulary by using a vector cosine similarity algorithm;
the instructions to acquire a vocabulary pair and a similarity value of the vocabulary pair in a video file library cause the electronic device to: extract a title of a video from a preset video file library, and add vocabularies appearing in the same title into the preliminary synonym vectors of each other; for a vocabulary w1 and a synonym w2 corresponding to w1, calculate the similarity
$$rel ( w 1 , w 2 ) = \sqrt{\frac{count ( w 1 , w 2 ) * count ( w 1 , w 2 )}{count ( w 1 ) * count ( w 2 )}}$$
between the vocabulary and each preliminary synonym vector corresponding to the vocabulary; wherein, count (w1) is the number of titles in which w1 appears, count (w2) is the number of titles in which w2 appears, and count (w1, w2) is the number of titles in which w1 and w2 appear simultaneously;
the instructions to acquire a vocabulary pair and a similarity value of the vocabulary pair in a search log record cause the electronic device to: take vocabularies appearing in the same query request and vocabularies in query requests that are different but provide the same search result as preliminary synonym vectors of each other; for a vocabulary w1 and a synonym w2 corresponding to w1, calculate the similarity
$$rel ( w 1 , w 2 ) = \sqrt{\frac{count ( w 1 , w 2 ) * same ( w 1 , w 2 )}{count ( w 1 ) * count ( w 2 )}}$$
between the vocabulary and each preliminary synonym vector corresponding to the vocabulary; wherein, count (w1) is the number of queries in which w1 appears, count (w2) is the number of queries in which w2 appears, count (w1, w2) is the number of queries in which w1 and w2 appear simultaneously, and same (w1, w2) is the number of different queries with the same search result in which w1 and w2 appear.

8. The non-volatile computer-readable storage medium according to claim 7, wherein, the electronic device is further caused to:
summarize and average the similarity values of each vocabulary pair in the dictionary, the video file library and the search log record, and store the average value in the candidate synonym library;
wherein the candidate synonym library is denoted (w1, w2, T1, T2, T3, T), wherein T1 is the similarity value of vocabulary pair w1, w2 in the dictionary, T2 is the similarity value of vocabulary pair w1, w2 in the video file library, T3 is the similarity value of vocabulary pair w1, w2 in the search log record, and T is an average similarity value of vocabulary pair w1, w2.

9. The non-volatile computer-readable storage medium according to claim 8, wherein, the instructions to train and obtain a synonym model cause the electronic device to:
extract the 1^{st} to the n^{th} data information (w1, w2, T) from the candidate synonym library as an input, extracting the (n+1)^{th} to the 2n^{th} data information (w1, w2, T) from the candidate synonym library as an output, and train a gradient boosting decision tree model;
obtain a synonym gradient boosting decision tree model:
F(T)=α₁β₁(T)+α₂β₂(T)+ . . . +αₘβₘ(T);
wherein, β₁-βₘ represents m decision trees, α₁-αₘ represents the weight of each decision tree, and T represents an average value obtained by summarizing and averaging the similarity values of three vectors corresponding to each vocabulary pair.

10. The non-volatile computer-readable storage medium according to claim 9, wherein, the instructions to substitute the similarity value corresponding to each vocabulary pair in the candidate synonym library into the synonym model cause the electronic device to:
substitute the similarity value corresponding to each vocabulary pair in the candidate synonym library into the synonym gradient boosting decision tree model, and acquire an output value from the synonym gradient boosting decision tree model.

11. An electronic device, comprising:
at least one processor; and
a memory;
wherein the memory stores instructions executable by the at least one processor, and the instructions are executed by the at least one processor to cause the at least one processor to:
acquire a vocabulary pair and a similarity value of the vocabulary pair in a dictionary, a video file library and a search log record, and establish a candidate synonym library in which the vocabulary pair is associated with the similarity value of the vocabulary pair;
train and obtain a synonym model according to data information in the candidate synonym library;
obtain an output value by substituting the similarity value corresponding to each vocabulary pair in the candidate synonym library into the synonym model; and
store a vocabulary pair with an output value greater than a preset threshold in a synonym library.

12. The electronic device according to claim 11, wherein, the instructions to acquire a vocabulary pair and a similarity value of the vocabulary pair in a dictionary cause the at least one processor to:
encode all vocabularies in a dictionary, take the vocabularies appearing in the vocabulary explanation of each vocabulary as preliminary synonym vectors, arrange the preliminary synonym vectors according to a tree structure, in which each vocabulary is taken as a parent node and the preliminary synonym vectors thereof are taken as child nodes, and then calculate a similarity value between each vocabulary and each preliminary synonym vector corresponding to the vocabulary by using a vector cosine similarity algorithm;
the instructions to acquire a vocabulary pair and a similarity value of the vocabulary pair in a video file library cause the at least one processor to: extract a title of a video from a preset video file library, and add vocabularies appearing in the same title into the preliminary synonym vectors of each other; for a vocabulary w1 and a synonym w2 corresponding to w1, calculate the similarity
$$rel ( w 1 , w 2 ) = \sqrt{\frac{count ( w 1 , w 2 ) * count ( w 1 , w 2 )}{count ( w 1 ) * count ( w 2 )}}$$
between the vocabulary and each preliminary synonym vector corresponding to the vocabulary; wherein, count (w1) is the number of titles in which w1 appears, count (w2) is the number of titles in which w2 appears, and count (w1, w2) is the number of titles in which w1 and w2 appear simultaneously;
the instructions to acquire a vocabulary pair and a similarity value of the vocabulary pair in a search log record cause the at least one processor to: take vocabularies appearing in the same query request and vocabularies in query requests that are different but provide the same search result as preliminary synonym vectors of each other; for a vocabulary w1 and a synonym w2 corresponding to w1, calculate the similarity
$$rel ( w 1 , w 2 ) = \sqrt{\frac{count ( w 1 , w 2 ) * same ( w 1 , w 2 )}{count ( w 1 ) * count ( w 2 )}}$$
between the vocabulary and each preliminary synonym vector corresponding to corresponding to the vocabulary; wherein, count (w1) is the number of queries in which w1 appears, count (w2) is the number of queries in which w2 appears, count (w1, w2) is the number of queries in which w1 and w2 appear simultaneously, and same (w1, w2) is the number of different queries with the same search result in which w1 and w2 appear.

13. The electronic device according to claim 11, wherein, the at least one processor is further caused to:
summarize and average the similarity values of each vocabulary pair in the dictionary, the video file library and the search log record, and store the average value in the candidate synonym library;
wherein the candidate synonym library is denoted (w1, w2, T1, T2, T3, T), wherein T1 is the similarity value of vocabulary pair w1, w2 in the dictionary, T2 is the similarity value of vocabulary pair w1, w2 in the video file library, T3 is the similarity value of vocabulary pair w1, w2 in the search log record, and T is an average similarity value of vocabulary pair w1, w2.

14. The electronic device according to claim 13, wherein, the instructions to train and obtain a synonym model cause the at least one processor to:
extract the 1^{st} to the n^{th} data information (w1, w2, T) from the candidate synonym library as an input, extracting the (n+1)^{th} to the 2n^{th} data information (w1, w2, T) from the candidate synonym library as an output, and train a gradient boosting decision tree model;
obtain a synonym gradient boosting decision tree model:
F(T)=α₁β₁(T)+α₂β₂(T)+ . . . +αₘβₘ(T);
wherein, β₁-βₘ represents m decision trees, α₁-αₘ represents the weight of each decision tree, and T represents an average value obtained by summarizing and averaging the similarity values of three vectors corresponding to each vocabulary pair.

15. The electronic device according to claim 14, wherein, the instructions to substitute, into the synonym model, the similarity value corresponding to each vocabulary pair in the candidate synonym library comprises:
substitute the similarity value corresponding to each vocabulary pair in the candidate synonym library into the synonym gradient boosting decision tree model, and acquire an output value from the synonym gradient boosting decision tree model.
